(19) United States
(12) Patent Application Publication
(10) Pub. No.: US 2026/0337839 A1
(43) Pub. Date: Oct. 29, 2026

(54) Nonwoven Webs Made from Multicomponent Filaments Having High Loft and Softness Characteristics

(71) Applicant: Kimberly-Clark Worldwide, Inc., Neenah, WI (US)

(72) Inventors: Timothy D. Ferguson, Alpharetta, GA (US); Sara Honarbakhsh, Alpharetta, GA (US); Esfandiar Khatiblou, Alpharetta, GA (US); Jeffrey Krueger, Roswell, GA (US); Eric E. Lennon, Roswell, GA (US)

(21) Appl. No.: 19/484,188

(22) PCT Filed: Jun. 4, 2024
(86) PCT No.: PCT/US2024/032373

§ 371 Date: Nov. 13, 2025

Related U.S. Application Data
(60) Provisional application No. 63/507,281, filed on Jun. 9, 2023.

(51) Int. Cl. D04H 1/4391; B32B 5/02; B32B 5/26; D01F 1/10; D01F 6/06; D04H 1/4291; D04H 1/4374; D04H 1/4382; D04H 1/56; D04H 3/16

(52) U.S. Cl. CPC D04H 1/43918; B32B 5/022; B32B 5/266; D01F 1/10; D01F 6/06; D04H 1/4291; D04H 1/4374; D04H 1/43828; D04H 1/43832; D04H 1/56; D04H 3/16; B32B 2262/0253; B32B 2262/124; B32B 2262/16; B32B 2307/718; D10B 2321/021; D10B 2321/022

(57) ABSTRACT

Multicomponent filaments, nonwoven webs made from the multicomponent filaments, and processes for forming nonwoven webs are disclosed. In accordance with the present invention, the multicomponent filaments contain a crimp enhancement additive. The use of the crimp enhancement additive in combination with a thermal bonding pattern results in nonwoven webs having enhanced softness and an increase in bulk/specific volume.

### CROSS-REFERENCE TO RELATED APPLICATION

The present application is related and has right of priority to U.S. Provisional Patent Application No. 63/507,281 filed on Jun. 9, 2023, which is incorporated by reference in its entireties for all purposes.

### FIELD

The present disclosure is generally directed to multicomponent filaments, nonwoven webs made from the multicomponent filaments, and processes for forming the nonwoven webs. In accordance with the present invention, the multicomponent filaments contain a crimp enhancement additive. More particularly, the present disclosure is directed to incorporating an additive into one of the polymers used to make multicomponent filaments in combination with a thermal bonding pattern that produces nonwoven webs with unexpectedly better bulk and/or softness properties.

### BACKGROUND

Nonwoven fabrics are used to make a variety of products which desirably have particular levels of softness, strength, uniformity, liquid handling properties such as absorbency, and other physical properties. Such products include towels, industrial wipers, incontinence products, filter products, infant care products such as baby diapers, absorbent feminine care products, and garments such as safety and other protective apparel. These products are often made with multiple layers of nonwoven fabrics to obtain the desired combination of properties. For example, disposable baby diapers made from polymeric nonwoven fabrics may include a soft and porous liner layer which fits next to the baby's skin, an impervious outer cover layer which is strong and soft, and one or more interior liquid handling layers which are soft, bulky and absorbent.

Nonwoven fabrics such as the foregoing are commonly made by melt spinning thermoplastic materials, including through spunbond processes. Such fabrics made through a spunbond process are sometimes referred to as spunbond materials or spunbond nonwoven polymeric webs. Spunbond nonwoven polymeric webs are typically made from thermoplastic materials by extruding the thermoplastic material through a spinneret and drawing the extruded material into filaments with a stream of high velocity air to form a random web on a collecting surface.

Spunbond materials with desirable combinations of physical properties, especially combinations of softness, strength, and absorbency, have been produced, but limitations have been encountered. For example, for some applications, polymeric materials such as polypropylene may have a desirable level of strength but not a desirable level of softness. On the other hand, materials such as polyethylene may, in some cases, have a desirable level of softness but not a desirable level of strength.

In an effort to produce nonwoven materials having desirable combinations of physical properties, spunbond nonwoven polymeric fabrics made from multicomponent or bicomponent filaments and fibers have been developed. Multicomponent polymeric fibers or filaments include two or more polymeric components which remain distinct, and bicomponent polymeric fibers or filaments include two polymeric components which remain distinct. As used herein, the terms “filaments” and “fibers” mean strands of material and may be used interchangeably. In particular embodiments, the filaments of the present disclosure may be continuous or the filaments of the present disclosure may be discontinuous and thus have a definite length. The first and subsequent components of multicomponent filaments are arranged in substantially distinct zones across the cross-section of the filaments and extend continuously along the length of the filaments. Typically, one component exhibits different properties than the other so that the filaments exhibit properties of the two components. For example, one component may be polypropylene which is relatively strong and the other component may be polyethylene which is relatively soft. The end result is a strong yet soft nonwoven fabric. However, use of different polymers in the multicomponent filaments can make recycling the multicomponent filaments and webs made therefrom impractical or impossible if one of the polymers is not recyclable, as it would be difficult to separate the polymers to extract the recyclable one.

To increase the specific volume or fullness of the multicomponent nonwoven webs for improved fluid management performance or for enhanced “cloth-like” feel of the webs, the bicomponent filaments or fibers are often crimped. Multicomponent filaments may be either mechanically crimped or, if the appropriate polymers are used, naturally crimped. As used herein, a naturally crimped filament is a filament that is crimped by activating a latent crimp contained in the filaments. For instance, in one embodiment, filaments can be naturally crimped by subjecting the filaments to a gas, such as a heated gas, after being drawn.

In general, it is far more preferable to construct filaments that can be naturally crimped as opposed to having to crimp the filaments in a separate mechanical process. Difficulties have been experienced in the past, however, in producing filaments that will crimp naturally to the extent required for the particular application. Also, it has been found to be very difficult to produce naturally crimped fine filaments, such as filaments having a linear density of less than two denier. Specifically, the draw force used to produce fine filaments usually prevents or removes any meaningful latent crimp attributes that may be contained in the filaments.

Another problem experienced in the past is being able to produce a consolidated nonwoven web from the crimped filaments that has sufficient strength while remaining soft. Consequently, a need currently exists for a nonwoven web made from crimped filaments that has high softness characteristics. A need also exists for a nonwoven web made from crimped filaments that has high specific volume characteristics even after being consolidated through a bonding process.

### SUMMARY

The present disclosure recognizes and addresses the foregoing disadvantages, and others of prior art constructions and methods.

In general, the present disclosure is directed to nonwoven webs having excellent softness characteristics and/or high specific volume characteristics. The nonwoven webs contain crimped multicomponent filaments. A crimping enhancement additive is incorporated into the filaments that causes the filaments to inherently crimp. The crimped multicomponent filaments contained within the nonwoven web are combined with a particular thermal bonding pattern that has been found to dramatically and unexpectedly increase specific volume and/or softness.

In one aspect, for instance, the present disclosure is directed to a nonwoven web comprising crimped multicomponent filaments. The multicomponent filaments include a first component comprising a polyolefin and a second component comprising a polyolefin blended with a crimp enhancement additive. In accordance with the present disclosure, the nonwoven web has been thermally bonded according to a bonding pattern that covers less than 16% of the surface area of a surface of the nonwoven web. For instance, the bonding pattern can cover less than about 15% of the surface area, such as less than about 14% of the surface area, such as less than about 13% of the surface area, such as less than about 12% of the surface area, such as less than about 11% of the surface area, and generally greater than about 5% of the surface area, such as greater than about 8% of the surface area, such as greater than about 9% of the surface area. The bonding pattern can vary depending upon the particular application. In one aspect, the bonding pattern is comprised of point bonds. The point bonds can form discrete shapes, such as wave-like shapes, or can comprise a grid pattern.

In one aspect, the nonwoven web displays excellent specific volume characteristics. For instance, the specific volume of the web can be greater than 19.3 cm³/g, such as greater than about 20 cm³/g, such as greater than about 21 cm³/g, such as greater than about 22 cm³/g, such as greater than about 23 cm³/g, such as greater than about 24 cm³/g, such as greater than about 25 cm³/g, such as greater than about 26 cm³/g, such as greater than about 27 cm³/g, and generally less than about 40 cm³/g.

The nonwoven web can also display excellent softness characteristics. For instance, the nonwoven web can display a TS7 softness of less than about 3.8, such as less than about 3.7, such as less than about 3.5, such as less than about 3.3, such as less than about 3.1, such as less than about 2.9, such as less than about 2.7, such as less than about 2.5, and generally greater than 1. The nonwoven web can also display a TS750 softness of less than about 3.5, such as less than about 3.3, such as less than about 3.1, such as less than about 2.9, such as less than about 2.7, such as less than about 2.5, such as less than about 2.3, and generally greater than about 1. The TS7 softness and the TS750 softness can be determined using a TSA analyzer.

Nonwoven webs made according to the present disclosure can generally have a basis weight of from about 10 gsm to about 60 gsm, such as from about 13 gsm to about 45 gsm, such as from about 15 gsm to about 40 gsm, such as from about 15 gsm to about 30 gsm. The crimped multicomponent filaments can generally have greater than about 5 crimps per inch, such as at least about 10 crimps per inch, such as at least about 15 crimps per inch, such as at least about 20 crimps per inch, and generally less than about 50 crimps per inch. The filaments can be continuous filaments or discontinuous filaments.

The crimp enhancement additive used in accordance with the present disclosure can comprise a polyolefin homopolymer, such as a polypropylene homopolymer. The crimp enhancement additive can have a melt flow rate of less than about 20 g/10 min, such as from about 8 g/10 min to about 16 g/10 min. In one aspect, the second component of the crimped multicomponent filaments can comprise the crimp enhancement additive as described above combined with a polypropylene polymer. The second component can optionally contain a white pigment and/or a secondary fatty acid amide. The first component contained within the multicomponent filaments can contain a polypropylene polymer blended with a polypropylene copolymer. The polypropylene copolymer can be a random copolymer of propylene and ethylene. The second component can also contain a white pigment and a secondary fatty acid amide. The weight ratio between the first component and the second component can be from about 50:50 to about 90:10, such as from about 50:50 to about 65:35. The crimped multicomponent filaments can have a denier of from about 0.5 to about 3, such as from about 1 to about 2.5.

In one embodiment, the nonwoven web comprises a spunbond web.

In one embodiment, the multicomponent filaments comprise greater than about 90% polypropylene by weight. Preferably, the multicomponent filaments comprise greater than about 95% polypropylene by weight. Preferably, the multicomponent filaments comprise greater than about 97% polypropylene by weight.

Other features and aspects of the present disclosure are discussed in greater detail below.

### BRIEF DESCRIPTION OF THE DRAWINGS

A full and enabling disclosure of the present invention, including the best mode thereof, to one of ordinary skill in the art, is set forth more particularly in the remainder of the specification, including reference to the accompanying figures, in which:

FIG. 1 is a schematic drawing of a process line for making an embodiment of the present invention;

FIG. 2A is a schematic drawing illustrating the cross section of a filament made according to an embodiment of the present disclosure with the polymer components A and B in a side-by-side arrangement;

FIG. 2B is a schematic drawing illustrating the cross section of a filament made according to an embodiment of the present disclosure with the polymer components A and B in an eccentric sheath/core arrangement;

FIG. 3 is a plan view of one embodiment of a nonwoven web made in accordance with the present disclosure illustrating a bonding pattern; and

FIG. 4 is a plan view of another embodiment of a nonwoven web made in accordance with the present disclosure illustrating a bonding pattern.

Repeat use of reference characters in the present specification and drawings is intended to represent same or analogous features or elements of the invention.

### DETAILED DESCRIPTION

It is to be understood by one of ordinary skill in the art that the present discussion is a description of exemplary embodiments only and is not intended as limiting the broader aspects of the present invention, which broader aspects are embodied in the exemplary construction.

The present disclosure is generally directed to multicomponent filaments, to nonwoven webs, including spunbond webs, produced from the filaments, and to a process for forming nowoven webs from the filaments. In particular, the filaments are inherently crimped into, for instance, a helical arrangement. In accordance with the present disclosure, the nonwoven web containing the crimped filaments is subjected to a thermal bonding pattern that consolidates the web while unexpectedly producing a final product with enhanced softness and/or increased specific volume. The nonwoven webs also have improved fluid management properties and have an enhanced cloth-like appearance and/or feel.

Multicomponent filaments for use in the present disclosure contain at least two polymeric components. The polymeric components can be, for instance, in a side-by-side configuration or in an eccentric sheath-core configuration. The polymeric components are selected from semi-crystalline and crystalline thermoplastic polymers which have different crystallization and/or solidification rates with respect to each other in order for the filaments to undergo inherent crimping. More particularly, one of the polymeric components has a faster solidifying and/or crystallizing rate than the other polymeric component.

As used herein, the solidification and/or crystallization rate of a polymer refers to the rate at which a softened or melted polymer hardens and forms a fixed structure. It is believed that the solidification and/or crystallization rate of a polymer is influenced by different parameters including the melting temperature and the rate of crystallization of the polymer. For instance, a fast solidifying and/or crystallizing polymer typically has a melting point that is about 10 °F or higher, more desirably about 20 °F or higher, and most desirably about 30 °F or higher than a polymer that has a slower solidifying and/or crystallizing rate. It should be understood, however, that both polymeric components may have similar melting points if their crystallization rates are measurably different.

It is believed that the inherent crimping of multicomponent filaments is created in the filaments due to the differences in the shrinkage properties, i.e., differences in the rates of solidification and/or crystallization, between the polymeric components.

The present disclosure is directed to adding a crimp enhancement additive to one of the polymeric components to produce a faster solidification and/or crystallization rate in that component. In this manner, the differences between the solidification and/or crystallization rates of the two (or more) polymeric components creates multicomponent filaments exhibiting an inherent crimping. In particular, the crimp enhancement additive of the present disclosure is a polyolefin homopolymer, preferably a polypropylene homopolymer.

As used herein, “inherent crimping” means that the multicomponent filaments crimp upon solidifying and/or crystallizing without the use of any further crimping treatments, i.e., treatments to produce or activate crimp. Prior methods of producing crimp in multicomponent filaments have required that the filaments be subjected to additional steps to produce, enhance, or activate crimping in the filaments. Such steps include using heat to activate crimping during the drawing of the filaments or through air drying or the use of an air knife. In comparison, the multicomponent filaments of the present disclosure exhibit a high degree of crimp without the use of any of these additional or subsequent crimping treatments. Accordingly, the present disclosure allows for simplified and less energy intensive processes for the production of highly crimped multicomponent filaments and nonwoven webs formed therefrom.

In one embodiment, the multicomponent filaments have an average of at least about five crimps per inch. Preferably, the multicomponent filaments have an average of at least about 10 crimps per inch or at least about twenty crimps per inch or at least about 30 crimps per inch or at least about 40 crimps per inch or at least about 50 crimps per inch.

Besides creating multicomponent filaments that have an inherent crimp, the present disclosure is also directed to applying a particular bond pattern to nonwoven webs containing the crimped multicomponent filaments. It was discovered that the combination of the crimped filaments with a thermal bond pattern can produce webs having unexpectedly better softness properties and/or increased specific volume. The bond pattern, for instance, can be applied to a surface of the nonwoven web in a manner that occupies a relatively low surface area of the web while providing consolidation of the web. In one aspect, the bond pattern can be comprised of point bonds that are applied to a surface of the nonwoven web in a pattern. The overall pattern may comprise a plurality of discrete shapes or can comprise a grid-like pattern. For instance, fabrics and webs made from the filaments have a higher specific volume and a lower density.

The webs and fabrics of the present disclosure are particularly useful for making various products including liquid and gas filters, personal care articles and garment materials. Personal care articles include infant care products such as disposable baby diapers, child care products such as training pants, and adult care products such as incontinence products and feminine care products. Suitable garments include safety apparel, work wear, and the like.

As described above, the fabric of the present disclosure can be made from continuous or discontinuous multicomponent polymeric filaments comprising at least first and second polymeric components. One embodiment of the present disclosure is a polymeric fabric including continuous bicomponent filaments comprising a first polymeric component A and a second polymeric component B. The bicomponent filaments have a cross-section, a length, and a peripheral surface. The first and second components A and B are arranged in substantially distinct zones across the cross-section of the bicomponent filaments and extend continuously along the length of the bicomponent filaments. The second component B, in some embodiments, constitutes at least a portion of the peripheral surface of the bicomponent filaments continuously along the length of the bicomponent filaments.

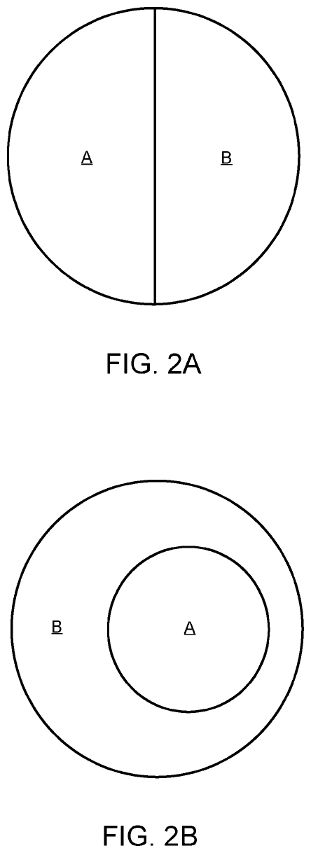

The first and second components A and B, for example, are arranged in either a side-by-side arrangement as shown in FIG. 2A or an eccentric sheath/core arrangement as shown in FIG. 2B so that the resulting filaments exhibit an inherent helical crimp. Polymer component A is the core of the filament and polymer component B is the sheath in the sheath/core arrangement. Methods for extruding multicomponent polymeric filaments into such arrangements are well-known to those of ordinary skill in the art.

Polymer component A and polymer component B must be selected so that the resulting bicomponent filament is capable of developing an inherent crimp. Preferably, polymer component B has a faster solidification rate than polymer component A. For instance, in one embodiment, polymer component B can have a higher melting temperature than polymer component A. In one embodiment, the rate of solidification and/or crystallization of the second component is at least about 5% faster than the rate of solidification and/or crystallization of the first component. Preferably, the rate of solidification and/or crystallization of the second component is at least about 10% faster, at least about 15%, at least about 20% faster, at least about 25% faster, at least about 30% faster, at least about 40% faster, at least about 50% faster, at least about 60% faster, at least about 70% faster, at least about 80% faster, at least about 90% faster, or at least about 100% faster than the rate of solidification and/or crystallization of the first component.

In one aspect, polymer component A comprises polypropylene and component B also comprises polypropylene. When component A polypropylene and component B is also polypropylene, the bicomponent filaments may comprise greater than about 90% by weight polypropylene. More preferably, the bicomponent filaments may comprise greater than about 95% by weight polypropylene and greater than about 97% by weight polypropylene. Constructing the nonwoven web almost exclusively from polypropylene polymers, for instance, can increase the ability of the material to be recycled.

In one embodiment, the ratio of the first polymeric component (component A) to the second polymeric component (component B) is from about 50:50 to about 90:10 by weight. Preferably, the ratio of the first polymeric component (component A) to the second polymeric component (component B) is from about 50:50 to about 65:35 or from about 50:50 to about 75:25 by weight.

Suitable materials for preparing the multicomponent filaments of the present disclosure include fiber grade polypropylene with a melt flow rate of greater than about 20 g/10 min, such as greater than about 25 g/10 min, such as greater than about 30 g/10 min, such as greater than about 35 g/10 min, and less than about 70 g/10 min, such as between about 20 g/10 min and about 55 g/10 min at 230 °C and a load of 2.16 kg as determined in accordance with ASTM D1238, such as pp 3155E5, a polypropylene homopolymer, available from ExxonMobil of Houston, Tex.

In one aspect, the crimp enhancement additive of the present disclosure is a polyolefin homopolymer. More preferably, the crimp enhancement additive is a polypropylene homopolymer. Preferably, the crimp enhancement additive is free of phthalates. For instance, the crimp enhancement additive can be a polypropylene homopolymer having an MFR (melt flow rate) of 14 g/10 min at 230 °C and a load of 2.16 kg as determined in accordance with ASTM D1238 and a density of 0.9 g/cm³.

In an embodiment, the crimp enhancement additive is present in the second component (component B) in an amount between about 5% and 50% by weight based on the weight of the second component. Preferably, the crimp enhancement additive is present in the second component (component B) in an amount between about 10% and 40% by weight based on the weight of the second component or between about 20% and 30% by weight based on the weight of the second component.

In an embodiment, the crimp enhancement additive has a melt flow rate (MFR) of less than about 20 g/10 min as measured at a temperature of 230 °C and a load of 2.16 kg as determined in accordance with ASTM D1238. Preferably, the crimp enhancement additive has a melt flow rate (MFR) between about 5 g/10 min and about 20 g/10 min or about 8 g/10 min to about 16 g/10 min or about 10 g/10 min to about 15 g/10 min as measured at a temperature of 230 °C and a load of 2.16 kg as determined in accordance with ASTM D1238.

In an embodiment, the multicomponent filaments include two polymeric components A and B. Each of components A and B may also include additional ingredients in minor amounts. As used herein, the term “minor amount” means less than about 25% by weight of the component to which the ingredient is added. Suitable additional ingredients for use in the multicomponent filaments of the present disclosure include softness/loft enhancers, pigments, and slip aids.

Suitable pigments include white pigments such as titanium dioxide zinc dioxide. Preferably, the pigment is a white pigment such as SCC-4837, titanium dioxide, available from the Standridge Color Corporation, Social Circle, Ga. In an embodiment, the white pigment is present in the first component in an amount of about 1% by weight based on the weight of the first component. Preferably, the white pigment is present in the first component in an amount between about 0.5% and about 3% by weight or between about 1.0% and about 1.5% based on the weight of the first component. In an embodiment, the white pigment is present in the second component in an amount of about 1% by weight based on the weight of the second component. Preferably, the white pigment is present in the second component in an amount between about 0.5% and about 3% by weight or between about 1.0% and about 1.5% based on the weight of the second component. Preferably, the white pigment is present in both components in the amounts discussed above.

Suitable softness/loft enhancers include polypropylene/polyethylene copolymers, such as Vistamaxx 7050, a polypropylene/polyethylene copolymer containing 13% by weight of ethylene and having a mass flow rate of 45 g/10 min at 230 °C and a load of 2.16 kg as determined in accordance with ASTM D1238, available from ExxonMobil and Americhem 48137, a secondary fatty acid amide, available from Americhem of Cuyahoga Falls, OH. In an embodiment, the softness/loft enhancers are present in the first component in an amount between about 10% and about 20% by weight based on the weight of the first component. Preferably, the softness/loft enhancers are present in the first component in an amount between about 5% and about 25% by weight based on the weight of the first component. In an embodiment, softness/loft enhancers are present in the second component in an amount of about 1.5% by weight based on the weight of the second component. Preferably, the softness/loft enhancers are present in the second component in an amount between about 0.5% and about 3% by weight based on the weight of the second component. Preferably, the softness/loft enhancers are present in both components in the amounts discussed above.

Suitable slip aids include primary and secondary amides. Primary amide slip aids include erucamide, available from the Sigma Aldrich, St. Louis, MO. In an embodiment, the slip aid is present in the first component in an amount of about 0.3% by weight based on the weight of the first component. Preferably, the slip aid is present in the first component in an amount between about 0.1% and about 1% by weight or between about 0.2% and about 0.5% based on the weight of the first component. In an embodiment, the slip aid is present in the second component in an amount of about 0.3% by weight based on the weight of the second component. Preferably, the slip aid is present in the second component in an amount between about 0.1% and about 1% by weight or between about 0.2% and about 0.5% based on the weight of the second component. Preferably, the slip aid is present in both components in the amounts discussed above.

In one aspect, component A can include polypropylene, a propylene/ethylene copolymer, a secondary fatty acid amide, and a white pigment. Component B can include polypropylene, the crimp additive, a secondary fatty acid amide, and a white pigment. In one embodiment, component A includes polypropylene, a propylene/ethylene copolymer, a secondary fatty acid amide, and a white pigment and component B includes polypropylene, the crimp additive, a secondary fatty acid amide, and a white pigment.

In order to combine the crimp enhancement additive with polymer component B, in one embodiment, the polymers can be dry blended and extruded together during formation of the multicomponent filaments. In an alternative embodiment, the crimp enhancement additive and polymer component B can be melt blended prior to being formed into the filaments of the present disclosure.

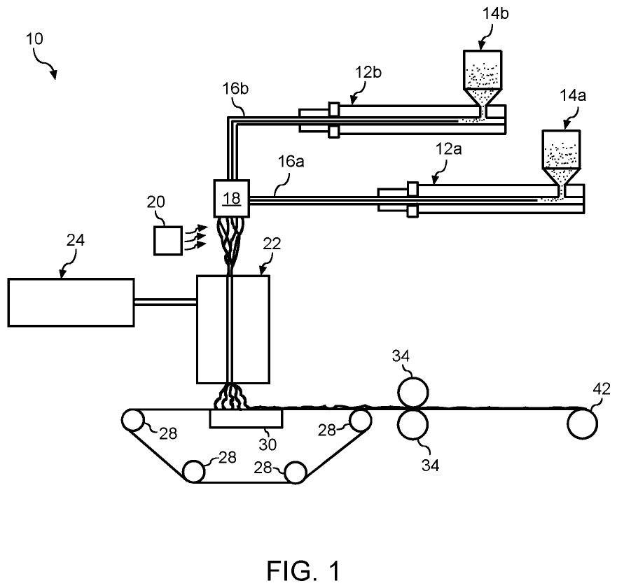

One process for producing multicomponent filaments and nonwoven webs according to the present disclosure will now be discussed in detail with reference to FIG. 1. The following process is similar to the process described in U.S. Pat. No. 5,382,400 to Pike et al., which is incorporated herein by reference in its entirety.

Turning to FIG. 1, a process line 10 for preparing a preferred embodiment of the present disclosure is disclosed. In some embodiments, the filaments described herein, for example, can be made through either a “closed” or “open” spunbond system, as described below. The process line 10 is arranged to produce bicomponent continuous filaments, but it should be understood that the present disclosure comprehends nonwoven fabrics made with multicomponent filaments having more than two components. For example, the fabric of the present disclosure can be made with filaments having three or four or more components.

The process line 10 includes a pair of extruders 12a and 12b for separately extruding a polymer component A and a polymer component B. Polymer component A is fed into the respective extruder 12a from a first hopper 14a and polymer component B is fed into the respective extruder 12b from a second hopper 14b. Polymer components A and 3 are fed from the extruders 12a and 12b through respective polymer conduits 16a and 16b to a spinneret 18.

Spinnerets for extruding bicomponent filaments are well-known to those of ordinary skill in the art and thus are not described here in detail. Generally described, the spinneret 18 includes a housing containing a spin pack which includes a plurality of plates stacked one on top of the other with a pattern of openings arranged to create flow paths for directing polymer components A and B separately through the spinneret. The spinneret 18 has openings arranged in one or more rows. The spinneret openings form a downwardly extending curtain of filaments when the polymers are extruded through the spinneret. For the purposes of the present disclosure, spinneret 18 may be arranged to form side-by-side or eccentric sheath/core bicomponent filaments illustrated in FIGS. 2A and 2B.

The process line 10 also includes a quench blower 20 positioned adjacent the curtain of filaments extending from the spinneret 18. Air from the quench air blower 20 quenches the filaments extending from the spinneret 18. The quench air can be directed from one side of the filament curtain as shown FIG. 1, or both sides of the filament curtain.

A fiber draw unit or aspirator 22 is positioned below the spinneret 18 and receives the quenched filaments. Fiber draw units or aspirators for use in melt spinning polymers are well-known as discussed above. Suitable fiber draw units for use in the process of the present disclosure include a linear fiber aspirator of the type shown in U.S. Pat. No. 3,802,817 and educative guns of the type shown in U.S. Pat. Nos. 3,692,618 and 3,423,266, or a closed system as shown in U.S. Pat. No. 4,340,563, the disclosures of which are incorporated herein by reference.

Generally described, the fiber draw unit 22 includes an elongate vertical passage through which the filaments are drawn by aspirating air entering from the sides of the passage and flowing downwardly through the passage. A compressor (in an open system) or blower (in a closed system) 24 supplies aspirating air to the fiber draw unit 22. The aspirating air draws the filaments and ambient air through the fiber draw unit.

An endless foraminous forming surface 26 is positioned below the fiber draw unit 22 and receives the continuous filaments from the outlet opening of the fiber draw unit. The forming surface 26 travels around guide rollers 28. A vacuum 30 positioned below the forming surface 26 where the filaments are deposited draws the filaments against the forming surface.

The process line 10 further includes a bonding apparatus such as thermal point bonding rollers 34. The bonding apparatus 34 applies a bonding pattern to the nonwoven web for consolidating the web and increasing strength. It was discovered, however, that certain bonding patterns can greatly enhance softness and/or increase specific volume in a dramatic and unexpected way. For instance, it was discovered that bonding patterns that occupy less surface area on the nonwoven web can produce webs with enhanced softness and increased specific volume. For instance, the bonding pattern applied to the web can occupy less than 16% of the surface area of one side of the nonwoven web. After the bonding apparatus 34, the process line 10 includes a winding roll 42 for taking up the finished fabric.

To operate the process line 10, the hoppers 14a and 14b are filled with the respective polymer components A and B. Polymer components A and B are melted and extruded by the respective extruders 12a and 12b through polymer conduits 16a and 16b and the spinneret 18. Although the temperatures of the molten polymers vary depending on the polymers used, when polypropylene is used for both components A and B, the preferred temperature of the polymers when extruded range from about 370 °F to about 530 °F and preferably range from 400 °F to about 470 °F.

As the extruded filaments extend below the spinneret 18, a stream of air from the quench blower 20 at least partially quenches the filaments to develop an inherent helical crimp in the filaments. The quench air preferably flows in a direction substantially perpendicular to the length of the filaments at a temperature of about 45 °F to about 90 °F and a velocity of from about 100 feet per minute to about 400 feet per minute.

After quenching, the filaments are drawn into the vertical passage of the fiber draw unit 22 by a flow of a gas, such as air, from the compressor or blower 24 through the fiber draw unit. The fiber draw unit is preferably positioned 30 to 60 inches below the bottom a of the spinneret 18. The filaments inherently crimp during solidification/crystallization during and throughout the drawing process.

The crimped filaments are deposited through the outlet opening of the fiber draw unit 22 onto the traveling forming surface 26. The vacuum 20 draws the filaments against the forming surface 26 to form an unbonded, nonwoven web of continuous filaments. The pattern in which the filaments are deposited on the forming surface is not critical. However, preferably, the filaments may be deposited on the forming surface in a uniform manner to produce a web with consistent properties.

The fiber draw unit 22 shown in FIG. 1 is an open system. In other embodiments, the fibers or filaments may be directed into a closed quench chamber and contacted with air or other cooling fluid.

In one aspect, the multicomponent filaments produced according to the process illustrated in FIG. 1 have a relatively low denier. For instance, the crimped multicomponent filaments can have a denier of less than about 3, such as less than about 2.5, such as less than about 2.25, such as less than about 2, such as less than about 1.75, such as less than about 1.5. The filaments generally have a denier of greater than about 0.5, such as greater than about 1. In one aspect, the crimped multicomponent filaments have a denier of between about 1 and about 2.

As discussed above, the crimp enhancement additive of the present disclosure allows for the production of highly crimped, fine filaments. In the past, naturally crimped fine filaments were difficult if not impossible to produce.

According to the present disclosure, filaments having an inherent crimp of at least about 10 crimps per inch can be produced at linear densities less than 2 denier, and particularly at less than about 1.2 denier. For most nonwoven webs, it is preferable for the filaments to have between about 10 crimps per inch and about 25 crimps per inch. Of particular advantage, filaments having an inherent crimp in the above range can be produced according to the present disclosure at lower linear densities.

The basis weight of the nonwoven web can depend upon various factors, including the particular application and the desired end use. The basis weight of the nonwoven web, for instance, can be greater than about 10 gsm, such as greater than about 13 gsm, such as greater than about 15 gsm, such as greater than about 18 gsm. The basis weight can be less than about 60 gsm, such as less than about 50 gsm, such as less than about 45 gsm, such as less than about 40 gsm, such as less than about 30 gsm, such as less than about 25 gsm.

As described above, in accordance with the present disclosure, a bonding pattern can be applied to the nonwoven web after the web has been formed. It was discovered that enhanced softness and/or increased specific volume can result if the bonding pattern occupies less than 16% of the surface area of one side of the nonwoven web, such as less than about 15% of the surface area, such as less than about 14% of the surface area, such as less than about 13% of the surface area, such as less than about 12% of the surface area, such as less than about 11% of the surface area, such as less than about 10% of the surface area. The bonding pattern occupies generally greater than about 5% of the surface area of one side of the nonwoven web, such as greater than about 6% of the surface area, such as greater than about 7% of the surface area, such as greater than about 8% of the surface area. In comparison, in the past, many bonding patterns occupied much greater surface area than the bonding patterns of the present disclosure. For instance, in the past, many conventional bonding patterns occupied at least 16% of the surface area of one side of the nonwoven web, such as at least 18% of the surface area, such as greater than about 20% of the surface area.

In one embodiment, the bonding pattern comprises a point bonded pattern. Point bonding generally refers to a process in which the nonwoven web is passed between a patterned roll and another roll, which may or may not be patterned. One or both rolls are typically heated. In accordance with the present disclosure, the point bonds form a pattern into at least one surface of the nonwoven web. The point bonds, for instance, can create a pattern comprised of discrete shapes or can create a pattern of intersecting lines, such as a grid-like pattern.

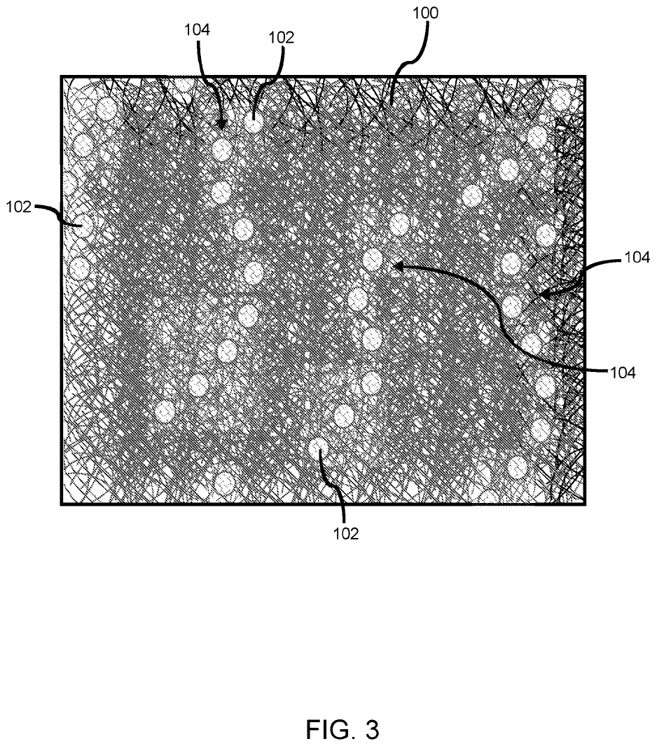

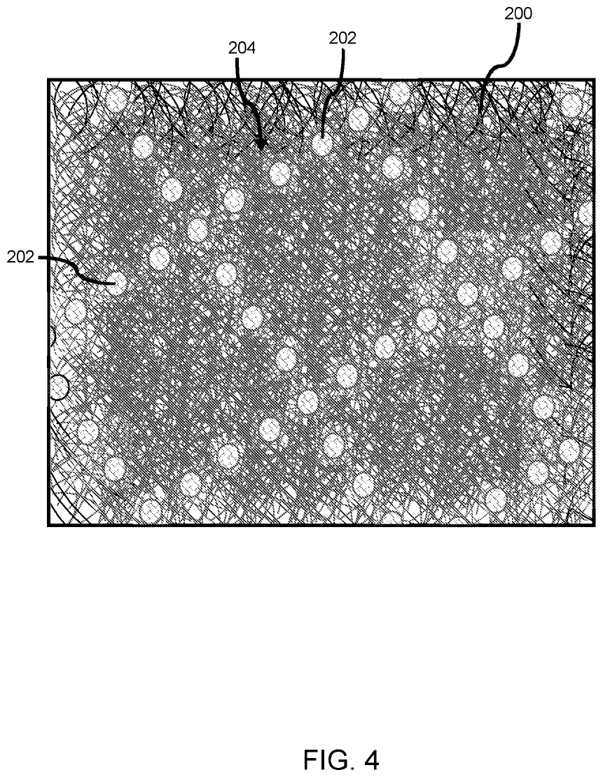

Exemplary bonding patterns that may be used in accordance with the present disclosure are shown in FIGS. 3 and 4. Referring to FIG. 3, a nonwoven web 100 made in accordance with the present disclosure is shown. A bonding pattern comprised of point bonds 102 has been applied to at least one surface of the web 100. In this embodiment, the point bonds 102 form discrete shapes 104 on a surface of the nonwoven web 100. The discrete shapes 104, for instance, can have a wave-like design. The number and density of the wave-like shapes can be adjusted so that the overall pattern occupies less than 16% of the surface area of the web 100.

Referring to FIG. 4, another embodiment of a nonwoven web 200 made in accordance with the present disclosure is shown. The nonwoven web 200 contains crimped multicomponent filaments. Applied to at least one surface of the nonwoven web 200 is a bonding pattern comprised of point bonds 202. In this embodiment, the point bonds 202 form lines that intersect. In this manner, the bonding pattern is comprised of a plurality of interconnected diamonds 204.

The selection of a bonding pattern that is comprised of discrete shapes or of an interconnected design can depend upon various factors. For instance, when applying a bonding pattern comprised of discrete shapes, the resulting nonwoven web may have a greater specific volume and/or softness. Applying an interconnected bonding pattern, such as a bonding pattern comprised of a grid-like design such as shown in FIG. 4, on the other hand, can reduce necking of the material during processing and use.

As shown in FIG. 1, after the bonding pattern is applied to the nonwoven web, the finished web is wound onto the winding roller 42 and is ready for further treatment or use. When used to make liquid absorbent articles, the fabric of the present disclosure may be treated with conventional surface treatments or contain conventional polymer additives to enhance the wettability of the fabric. For example, the fabric of the present disclosure may be treated with polyalkylene-oxide modified siloxanes and silanes such as polyalkylene-oxide modified polydimethyl-siloxane as disclosed in U.S. Pat. No. 5,057,361. Such a surface treatment enhances the wettability of the fabric.

As described above, nonwoven webs made according to the present disclosure can display an increased specific volume in combination with enhanced softness. The specific volume of the nonwoven web, for instance, can be greater than about 19.3 cm³/g, such as greater than about 20 cm³/g, such as greater than about 21 cm³/g, such as greater than about 22 cm³/g, such as greater than about 23 cm³/g, such as greater than about 24 cm³/g, such as greater than about 25 cm³/g, such as greater than about 26 cm³/g, such as greater than about 27 cm³/g. The specific volume is generally less than about 40 cm³/g, such as less than about 35 cm³/g. It was discovered that by using the bonding pattern of the present disclosure, the specific volume of the nonwoven web can be increased by greater than about 15%, such as greater than about 20%, such as even greater than about 25% in comparison to an identical nonwoven web bonded with a bonding pattern covering a greater surface area of the web.

The nonwoven web can also have excellent softness characteristics. For instance, the nonwoven web can display a TS7 softness of less than about 3.8, such as less than about 3.7, such as less than about 3.5, such as less than about 3.3, such as less than about 3.1, such as less than about 2.9, such as less than about 2.7, such as even less than about 2.5. The TS7 softness is generally greater than about 1. Similarly, the web can display a TS750 softness of less than about 3.5, such as less than about 3.3, such as less than about 3.1, such as less than about 2.9, such as less than about 2.7, such as less than about 2.5, such as less than about 2.3. The TS750 softness is generally greater than about 1. The TS7 softness and the TS750 softness can be measured using a TSA analyzer.

Spunbond meltblown spunbond (SMS) fabrics are tri laminate nonwoven fabrics. SMS is made up of a top layer of spunbond polypropylene, a middle layer of meltblown polypropylene, and a bottom layer of spunbond polypropylene. The nonwoven webs of the present disclosure are well suited for use in SMS fabrics/laminates. In an embodiment of the present disclosure, an SMS fabric/laminate is formed from a top layer of a nonwoven web of the present disclosure, a middle layer of meltblown polypropylene, and a bottom layer of a nonwoven web of the present disclosure.

Once produced, the nonwoven webs of the present disclosure can be used in many different and various applications. For instance, the webs can be used in filter products, in liquid absorbent products, in personal care articles, in garments, and in various other products.

### Test Procedures

### Caliper

In order to determine the caliper of a nonwoven web, a bulk tester such as Digimatic Indicator Gauge, Type DF 1050E, which is commercially available from Mitutoyo Corporation of Japan, may be used. The bulk tester includes a flat base and a smooth platen connected to an indicator gauge of the tester. The platen can have a diameter of about 3 inches and is capable of applying a uniform pressure of about 0.05 psi over a 3 inch diameter portion of the nonwoven web. A 4 inch×4 inch sample of the nonwoven web can be placed on the base and the platen applies pressure centrally to the sample such that no part of the platen overhangs the sample. Caliper measurements are made in a room that is about 23 °C and about 50% relative humidity. Caliper measurements can be made on a single layer or on multiple layers, such as by stacking four layers together.

The specific volume of the nonwoven web is the quotient of the caliper of the nonwoven web divided by the dry basis weight. Sheet specific volume can be expressed in cubic centimeters per gram.

### TS7 and TS750 Tests

TS7 and TS750 values were measured using an EMTEC Tissue Softness Analyzer (“TSA”) (Emtec Electronic GmbH, Leipzig, Germany) The TSA comprises a rotor with vertical blades which rotate on the test piece applying a defined contact pressure. Contact between the vertical blades and the test piece creates vibrations, which are sensed by a vibration sensor. The sensor then transmits a signal to a PC for processing and display. The signal is displayed as a frequency spectrum. For measurement of TS7 and TS750 values the blades are pressed against sample with a load of 100 mN and the rotational speed of the blades is 2 revolutions per second.

To measure TS7 and TS750 values two different frequency analyses are performed. The first frequency analysis is performed in the range of approximately 200 Hz to 1000 Hz, with the amplitude of the peak occurring at 750 Hz being recorded as the TS750 value. The TS750 value represents the surface smoothness of the sample. A high amplitude peak correlates to a rougher surface. A second frequency analysis is performed in the range from 1 to 10 KHZ, with the amplitude of the peak occurring at 7 kHz being recorded as the TS7 value. The TS7 value represents the softness of sample. A lower amplitude correlates to a softer sample. Both TS750 and TS7 values have the units dB V²rms.

### EXAMPLES

The present disclosure may be better understood with reference to the following Example.

### Example No. 1

Nonwoven webs were made according to the present disclosure having the following formula:

### Component A:

87% wt Polypropylene homopolymer
10% wt Polypropylene/polyethylene copolymer
1.5% wt Secondary fatty acid amide
1.5% wt Titanium dioxide

### Component B:

67% wt Polypropylene homopolymer
30% wt Crimp enhancement additive
1.5% wt Secondary fatty acid amide
1.5% wt Titanium dioxide

Nonwoven webs were made generally according to the process shown in FIG. 1. The bonding pattern applied to the nonwoven webs was varied. In particular, a bonding pattern was applied to Sample Nos. 1 and 2 that was similar to the bonding pattern illustrated in FIG. 3. The bonding pattern covers 10% of the surface area of one side of the nonwoven web. A bonding pattern was applied to Sample No. 3 similar to the pattern illustrated in FIG. 4. The bonding pattern covered about 10% of the surface area of one side of the nonwoven web. For purposes of comparison, a conventional bonding pattern was applied to Sample Nos. 4 and 5 which covered at least 16% of the surface area of one side of the nonwoven web. The bonding pattern was comprised of a pattern of small ovals. The nonwoven webs produced were tested for TS7 softness, TS750 softness, and caliper based on one sheet of material. The following results were obtained:

| Sample | Basis Weight | Caliper | TS7 | TS750 |
|---|---|---|---|---|
| No. | (gsm) | (mm) | softness | softness |
| 1 | 21 | 0.62 | 2.653 | 2.192 |
| 2 | 21 | 0.62 | 2.386 | 2.989 |
| 3 | 21.9 | 0.48 | 3.615 | 3.281 |
| 4 | 21.4 | 0.475 | 3.984 | 5.506 |
| 5 | 21.4 | 0.475 | 4.085 | 4.794 |

As shown above, nonwoven webs made according to the present disclosure displayed a greater caliper and thus a greater specific volume in combination with better softness characteristics.

Further nonwoven webs were made in accordance with the present disclosure and compared to various other nonwoven webs. In particular, Sample No. 6 below was made using the same process as Sample Nos. 1 and 2. Sample No. 7 below was made using the same process as Sample No. 3. Sample No. 8 was made using the same process as Sample Nos. 4 and 5. Sample No. 9 was made identical to Sample No. 6 except the multicomponent filaments did not contain the crimp enhancement additive. Sample No. 10 was made similar to Sample No. 8 except the filaments contained in the web were conventional bicomponent filaments containing a polyethylene component and a polypropylene component. Sample No. 11 is a commercially available nonwoven material advertised as having high loft and including a bonding pattern similar to Sample No. 8 and covering at least 18% of the surface area of one side of the web.

| Sample | Basis Weight | Caliper | Specific volume |
|---|---|---|---|
| No. | (gsm) | (4 layers) (mm) | (cm³/g) |
| 6 | 20 | 2.31 | 28.9 |
| 7 | 20 | 1.86 | 23.3 |
| 8 | 20 | 1.54 | 19.3 |
| 9 | 25 | 1.57 | 15.7 |
| 10 | 20 | 0.62 | 7.8 |
| 11 | 18 | 0.94 | 17.4 |

As shown above, nonwoven webs made according to the present disclosure displayed much greater specific volume properties.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

1. A nonwoven web comprising:
crimped multicomponent filaments comprising a first component comprising a polyolefin and a second component comprising a polyolefin blended with a crimp enhancement additive, and wherein the nonwoven web defines a first surface having a surface area and wherein the nonwoven web has been thermally bonded according to a bonding pattern that covers less than 16% of the surface area of the first surface and wherein the nonwoven web displays a specific volume of greater than 19.3 cm³/g.

2. A nonwoven web as defined in claim 1, wherein the bond pattern covers less than about 15% of the surface area of the first surface of the nonwoven web and covers greater than about 5% of the surface area of the first surface of the nonwoven web and wherein the bonding pattern comprises a pattern of point bonds.

3. A nonwoven web as defined in claim 1, wherein the nonwoven web displays a specific volume of greater than about 20 cm³/g and less than about 40 cm³/g.

4. A nonwoven web as defined in claim 1, wherein the nonwoven web displays a TS7 softness of less than about 3.8 and greater than about 1.

5. A nonwoven web as defined in claim 1, wherein the nonwoven web displays a TS750 softness of less than about 3.5 and greater than about 1.

6. A nonwoven web as defined in claim 1, wherein the nonwoven web has a basis weight of from about 10 gsm to about 60 gsm.

7. A nonwoven web as defined in claim 1, wherein the multicomponent filaments have at least about 5 crimps per inch.

8. A nonwoven web as defined in claim 1, wherein the crimp enhancement additive comprises a polypropylene homopolymer, the polypropylene homopolymer having a melt flow rate of less than about 20 g/10 min.

9. A nonwoven web has defined in claim 1, wherein the crimp enhancement additive is contained in the second component in an amount from about 5% to about 50% by weight.

10. A nonwoven web as defined in claim 1, wherein the polyolefin polymer contained within the second component comprises a polypropylene polymer having a melt flow rate of greater than about 20 g/10 min.

11. A nonwoven web as defined in claim 1, wherein the polyolefin polymer contained within the first component comprises a polypropylene polymer, the polypropylene polymer being blended with a polypropylene copolymer.

12. A nonwoven web as defined in claim 1, wherein the first component further comprises a secondary fatty acid amide.

13. A nonwoven web as defined in claim 1, wherein the weight ratio of the first component to the second component is from about 50:50 to about 90:10.

14. A nonwoven web as defined in claim 1, wherein the crimped multicomponent filaments have a denier of from about 0.5 to about 3.

15. A nonwoven web as defined in claim 1, wherein the crimped multicomponent filaments comprise continuous filaments or discontinuous filaments.

16. (canceled)

17. A nonwoven web as defined in claim 1, wherein the nonwoven web comprises a spunbond web, wherein the spunbond web is contained in a spunbond, meltblown, spunbond laminate.

18. (canceled)

19. A nonwoven web comprising:
crimped multicomponent filaments comprising a first component comprising a polyolefin and a second component comprising a polyolefin blended with a crimp enhancement additive, and wherein the nonwoven web defines a first surface having a surface area and wherein the nonwoven web has been thermally bonded according to a bonding pattern that covers less than 16% of the surface area of the first surface and wherein the nonwoven web displays a TS7 softness of less than about 3.8 and a TS750 softness of less than about 3.5.

20. A nonwoven web as defined in claim 19, wherein the nonwoven web displays a specific volume of greater than about 20 cm³/g and less than about 40 cm³/g.

21. A nonwoven web as defined in claim 19, wherein the nonwoven web has a basis weight of from about 13 gsm to about 45 gsm, wherein the crimped multicomponent filaments have at least about 15 crimps per inch, and wherein the crimp enhancement additive comprises a polypropylene homopolymer having a melt flow rate of less than about 20 g/10 min, and wherein the polyolefin polymer contained within the second component comprises a polypropylene polymer that is blended with the crimp enhancement additive, and wherein the first component comprises a polypropylene homopolymer blended with a polypropylene copolymer.

22. A nonwoven web as defined in claim 19, wherein the bonding pattern comprises a pattern of point bonds.

23. A nonwoven web as defined in claim 22, wherein the point bonds form a pattern of discrete shapes.

24. A nonwoven web as defined in claim 22, wherein the point bonds form a grid-like pattern.
